(19) United States
(12) Patent Application Publication
(10) Pub. No.: US 2025/0054413 A1
(43) Pub. Date: Feb. 13, 2025

(54) MEDICAL TRAINING MODEL

(71) Applicants: Jennifer FUCHS, Heidelberg (DE); Frederic WEICHEL, Limburgerhof (DE)

(72) Inventors: Jennifer FUCHS, Heidelberg (DE); Frederic WEICHEL, Limburgerhof (DE)

(21) Appl. No.: 18/291,528

(22) PCT Filed: Jul. 22, 2022
(86) PCT No.: PCT/EP2022/070674

§ 371 Date: Mar. 27, 2024

(30) Foreign Application Priority Data
Jul. 23, 2021 (DE) 10 2021 119 180.7

(51) Int. Cl. G09B 23/28; G09B 23/34

(52) U.S. Cl. CPC G09B 23/283; G09B 23/34

(57) ABSTRACT

The invention relates to three-dimensional models for simulating medical, in particular dental, treatments and methods for producing such a three-dimensional model, the three-dimensional model comprising at least one holding element for receiving artificial teeth and at least one artificial tooth, wherein the artificial tooth comprises at least one artificial tooth root, wherein the artificial tooth root is at least partly received in a recess of the holding element, and wherein a plurality of connecting strands is formed between the holding element and the artificial tooth, in particular the artificial tooth root.

The invention relates to three-dimensional models for simulating medical, in particular dental, treatments and methods for producing a three-dimensional model for simulating medical, in particular dental, treatments.

As in surgery, the use of training models to acquire and develop practical skills has been established in dentistry for many years. Models of oral cavities and jaw areas are used to demonstrate and simulate oral surgery procedures and operations. In addition to trainee dentists, oral and maxillofacial surgery residents also learn and train practical skills on these models so that they can later apply them to patients. In addition, simulation models for practical exercises also play an important role in the further careers of specialists and dentists, for example as part of further training seminars.

Common simulation models, which are mainly used in dental training, are typodonts from industrial manufacturers. These models are offered with interchangeable teeth and an interchangeable silicone gingival mask. The teeth are usually idealized stereotypes that cannot simulate anatomical variations such as extremely long or curved tooth roots. In these industrially manufactured models, the teeth are in direct contact with a simulated jawbone made of hard plastic, for example. They are usually fixed to the artificial bone using an adhesive or resin. However, this does not adequately reflect physiological conditions. In particular, it is not possible to achieve a physiological tooth removal experience with conventional dental models.

In general, the typodonts usually only show idealized eugnathia, i.e. normally shaped, intact dentitions that do not adequately reflect real situations as they occur in daily practice. The anatomical environment, such as nearby nerve cords, is usually not considered in these prefabricated standard models. Particularly in the area of the lower jaw, however, the exposure of large nerves with autonomous areas poses an enormous difficulty for surgeons or dentists. For example, the inferior alveolar nerve runs in the lower jawbone and supplies the entire ipsilateral lower third of the face with sensation. As a branch of the inferior alveolar nerve, the mental nerve supplies the chin with sensation. It is particularly at risk during implantation and wisdom tooth removal. The lingual nerve supplies the front part of the tongue with sensation and taste and is also particularly at risk during wisdom tooth extractions. Such special anatomical and possibly pathological conditions are generally not covered by the current simulation models.

In addition to these prefabricated standard models, individualized, usually high-priced models are now also constructed on the basis of selected scenarios or real patient situations, for example by creating a conventional impression of the real patient situation for the production of a plaster model. Nevertheless, no satisfactory means are yet available to provide vivid, physiologically accurate experiences in the simulation of surgical and dental interventions and to teach the realistic performance of an intervention in the oral cavity, for example for the purpose of extracting a tooth.

The present invention thus solves the problem to provide three-dimensional models for simulating medical, in particular dental, treatments, with which realistic experience can be gained at low cost in the performance of both routine and complex dental and/or surgical interventions. In addition, the present invention is based on the task of proposing an advantageous method for the cost-effective production of a three-dimensional model for simulating medical, in particular dental, treatments.

According to a first aspect of the invention the above-indicated problem for a three-dimensional model for simulating medical, in particular dental, treatments, comprising at least one holding element for receiving artificial teeth, at least one artificial tooth, wherein the artificial tooth comprises at least one artificial tooth root, wherein the artificial tooth root is at least partly received in a recess of the holding element is solved in that a plurality of connecting strands is formed between the holding element and the artificial tooth, in particular the artificial tooth root.

The holding element may for example be an artificial jawbone that is modeled on a human upper or lower jawbone. The model according to the invention may for example be used as an upper or lower jawbone model. Preferably, the three-dimensional model is configured such that it may be inserted into common phantoms. A Phantom may for example comprise a head, into which the three-dimensional model is inserted as an artificial upper and/or lower jawbone.

The at least one artificial tooth preferably has the appearance of a natural, human tooth and comprises preferably a dental crown, a dental neck and at least one tooth root, wherein the dental neck forms the transition between dental crown and tooth root. Thereby, it may be, for example, an imitation incisor, canine or molar tooth. The at least one tooth root starts on the dental neck and tapers preferably towards the root tip. It thus comprises preferably a conical form. Other forms are however possible, for example, the at least one tooth root may be uncommonly long, curved and/or bent.

To receive at least one artificial tooth, the holding element comprises at least one recess. In the recess, for example, the tooth root of the at least one artificial tooth may be at least partly, preferably fully received. The recess, for example, forms the counterpart of the tooth root of the artificial tooth, wherein the recess preferably is larger dimensioned, to allow for a gap and thereby some tolerance between the artificial tooth and holding element. The gap, for example, has a dimension of a few tenth of millimeters, preferably 0.1 to 0.6 mm, in particular preferably 0.1 to 0.3 mm.

There are a plurality of connecting strands formed between the holding element and the artificial tooth, in particular the artificial tooth root. Thereby, the artificial tooth may be embedded in the holding element advantageously and in a natural way. Through the connecting strands the gap may be preferably bridged and the artificial tooth, in particular the artificial tooth root, may be attached in the recess of the holding element in particular in a resilient way.

A natural embedding of the artificial tooth in the holding element is realized through the plurality of connecting strands, that connect the artificial tooth with the holding element. The connecting strands connect the at least one artificial tooth, in particular the at least one tooth root, with the holding element. It is conceivable that, for example, a material-locking connection is formed between the holding element and the at least one artificial tooth, in particular the at least one artificial tooth root, through at least one connecting strand, in particular the plurality of connecting strands. In this way, the artificial tooth, in particular the at least one artificial tooth root, may, for example, separated from the holding element only by destruction of the at least one connecting strand, in particular the plurality of connecting strands. The holding element and/or the at least one artificial tooth, in particular the at least one artificial tooth root, are in particular integrally formed with the connecting strands. In particular, the connecting strands are each connected with the artificial tooth, in particular the artificial tooth root, as well as with the holding element. In this way, the artificial tooth, in particular the artificial tooth root, is connected through the connecting strands with the holding element, in particular anchored therein.

It has been shown that the model according to the invention in this way allows for a particular realistic, physiological exact demonstration or simulation of routine as well as complex medical interventions, in particular dental treatments. There may be realized, for example, a semi-elastic connection between the holding element and the at least one artificial tooth, which provides a realistic surgical experience to the surgeon or dentist during removal of the tooth. A semi-elastic connection hereby means in particular that the connecting strands connect the at least one artificial tooth, in particular the at least one artificial tooth root, substantially stably with the holding element, these however may, at the same time, be formed partly moveable. The connection between the artificial tooth, in particular the at least one artificial tooth root, and the holding element may in particular be stable as well as resilient at the same time. This provides the advantage that forces acting on the artificial tooth are damped and the connecting strands, at the same time, do not break without further ado, for example when applying the slightest pull. The connecting strands, for example, may counteract a pull, a tilt and a rotation around the of the longitudinal axis of the artificial tooth.

It is conceivable, for example, that the connecting strands are formed at least partly elastic. The advantage herein is, in particular, that the connecting strands initially flex when forces are applied thereto and do not break easily. The elasticity of the connecting strands is, for example, influenced by its diameter and/or the used material. For example, connecting strands with a larger cross section are less elastic and thus result in a more rigid connection.

In addition, a different elasticity and/or a different hold of the at least one artificial tooth in the holding element may be achieved by a different length of the connecting strands. It is conceivable for example, that the connecting strands extend from a wavy shape, to transmit forces, such as, for example, tensile forces, that act on the artificial tooth, in particular the artificial tooth root.

A plurality of connecting strands, as used herein, comprises in particular two or more connecting strands, wherein between the holding element and the artificial tooth preferably three or more, in particular preferably four or more connecting strands are formed. Preferably there is an even number of connecting strands formed between the holding element and the artificial tooth. There may be formed, for example, two, four, six, eight, etc. connecting strands. Alternatively, there may be formed an uneven number of connecting strands, for example three, five, seven, nine, etc. The number of connecting strands preferably is between two and 100, preferably between 10 and 80, particularly preferable between 20 and 50. It is possible that far more connecting strands are provided. The number of connecting strands may be in particular selected depending on the intended purpose or the individual case, for example the desired stability of the tooth in the holding element. Preferably, the more connecting strands are formed between the artificial tooth, in particular the artificial tooth root, and the holding element, the tighter the hold.

The connecting strands may be formed with a rectangular, in particular square, circular and/or oval cross section. The connecting strands may be formed such as to taper towards the tooth and/or to the holding element. Other forms are conceivable. The diameter of the connecting strands may be preferably selected dependent on the desired strength of the artificial tooth in the holding element or dependent on the desired tenacity during removal of the tooth from the holding element. connecting elements with a larger diameter are less elastic and thereby result in a more rigid connection.

Connecting strands can be understood to mean fibers, for example. For example, the holding element and the artificial tooth, in particular the at least one artificial tooth root, are manufactured simultaneously by using an additive manufacturing method, in particular a print-in-place method, wherein the plurality of connecting strands are formed simultaneously between the holding element and the artificial tooth, in particular the artificial tooth root.

Optionally, the at least one artificial tooth, in particular the at least one artificial tooth root, may be additionally attached to the recess of the holding element by using glue or resin.

The connecting strands are preferably located on opposite sides of the artificial tooth, in particular of the at least one tooth root. Thereby, a uniform pressure acts on artificial tooth and, during removal, a uniform pull is necessary. Preferably, at least one connecting strand is located at the root tip of the at least one tooth root.

Through the connection of the at least one artificial tooth with the holding element via the plurality of connecting strands a physiological tooth removal may be advantageously simulated for a surgeon or a dentist. During a removal of the artificial tooth, the connecting strands between the holding element and the artificial tooth, in particular the at least one artificial tooth root, are substantially destroyed. The removal of the at least one artificial tooth may be achieved through a loosening of the artificial tooth in the recess of the holding element. For example, the artificial tooth is moved and/or turned, slowly and with a dosed force, back and forth by using pliers. By applying luxation movements, the connecting strands break, whereupon the artificial tooth may be removed.

Further, the realistic imitation of a plurality of further medical, in particular dental, treatments is allowed. The three-dimensional model according to the invention is particularly suited for the simulation of realistic extractions and osteotomies, root tip resections and plastic wound closures. Further, implantations can preferably be simulated with the model according to the invention. This may be particular interesting for using the model in line with advanced training of surgeons and dentists. The model according to the invention preferably allows a complication management, e.g. for root fractures, a flexible case design, e.g. ankylosed and retained teeth, in particular a patient case simulation as exact as possible. Preferably, different levels of difficulty of simulated interventions may be represented with the model according to the invention.

The model according to the invention preferably offers trainee as well as qualified dentists the possibility to train different surgical methods with a single model and with a particular realistic experience. In particular, the model is applicable for a plurality of training and/or demonstration scenarios. Thereby, it is possible to carry out removal of a single tooth or multiple teeth (for example removal of the upper right canine tooth as well as the left first molar tooth in one model), suturing techniques and/or osteometries on the same model. In particular, the model is also suitable for planning of operations and/or implantations. Thereby, the three-dimensional model may be used, for example, in line with virtual operation and/or implantation planning. In particular, X-rays and/or 3D scans may be performed on the three- dimensional model, which may be used during the planning.

Preferably, the model corresponds in form and material substantially with a natural upper and lower jaw, in particular a patient case. Additionally and preferably, it allows for a cost-effective production, for example by using an additive manufacturing method. An additive manufacturing method allows in particular for the simultaneous manufacturing of the holding element, of the at least one artificial tooth and/or the plurality of connecting strands. For example, the holding element, the at least one artificial tooth, in particular the at least one artificial tooth root, and the plurality of connecting strands are formed in one piece, wherein the connecting strands each connect the artificial tooth, in particular the artificial tooth root, with the holding element. The connecting strands preferably each end on the artificial tooth, in particular the artificial tooth root, and on the holding element. The connecting strands may be formed in particular semi-elastic.

According to a first embodiment of the model according to the invention, the connecting strands are substantially formed to be distributed across the whole root area. The at least one artificial tooth preferably has one or more artificial tooth roots. Depending on the position in the dentures it is usually distinguished between incisors, canines, premolars and molars. These may, in turn, comprise a different number of roots, wherein for incisors and canines one and for premolars and molars one to three roots is typical. Other numbers of roots are conceivable.

A distribution of the connecting strands substantially across the whole root area provides for a particular stable hold of the artificial tooth in the recess of the holding element. Through a uniform distribution, the model required a particular uniform pull during extraction of an artificial tooth, which provides the user with a particularly realistic operation experience.

The connecting strands preferably extend in the direction of the holding element. It is particularly preferable if the connecting strands connect the at least one artificial tooth, in particular the at least one artificial tooth root, in a direct and thereby shortest way. Thereby, the connection between the holding element and the artificial tooth or artificial tooth root is particularly rigid and requires little material. By using a different length of the connecting strands, a different elasticity and/or a different levels of hold of the at least one artificial tooth in the holding element. In particular, at least one connecting strand comprises an angle between 30 and 150 degrees, preferably between 45 and 135 degrees, further preferably substantially 90 Grad with respect to the tooth or root surface.

According to a further advantageous embodiment of the model according to the invention at least one connecting strand is formed laterally of the tooth root of the artificial tooth. Thereby it is in particular advantageous, if the connecting strands are located on opposite sides of the respective root, preferably symmetric with respect to the longitudinal axis of the at least one tooth, preferably the at least one tooth root. In particular, connecting strands that are formed laterally of the at least one tooth root allow for a physiological exact tooth removal experience for the surgeon or dentist. Additionally, or alternatively, the at least one connecting strand may be formed in proximity of the dental neck. The connecting strands between the at least one artificial tooth and the at least one holding element are preferably not visible from outside.

It is also conceivable that one connecting strand is formed on each of the root tip of each artificial tooth root and optionally, additionally, on at least one connecting strand on another position, for example laterally, of the artificial tooth, in particular the tooth root. Alternatively it is conceivable that a connecting strand is only formed on the root tip or no connecting strand is formed on a root tip.

The diameter of the connecting elements is preferably selected depending on the desired stability of the artificial tooth in the recess of the holding element. Connecting elements with a larger diameter provide for stronger connections and are less elastic. The diameter of the connecting elements may also be selected depending on the used materials. It is possible that all connecting elements have the same diameter. It is, however, also conceivable that the connecting elements have different diameters. It is thus, for example, conceivable that the diameter of at least one connection element, which is preferably formed on the root tip, is larger as the diameter of at least one other connection element, which is, for example, located laterally of the root.

The at least one holding element, the at least one artificial tooth, the at least one artificial tooth root and/or at least one connecting strand may at least partly be formed from the same of different materials. The holding element, the artificial tooth and/or the connecting strands are, for example, formed in one piece. It is conceivable, that the holding element may be formed from a different material as the at least one artificial tooth. The at least one artificial tooth may, in turn, be formed from the same material as the at least one connecting strand. It is also conceivable that the artificial tooth and at least one connecting strand are formed form different materials. The individual connecting strands of the plurality of connecting strands may also be formed form the same and/or different materials.

The at least one artificial tooth may be manufactured from a different material than the at least one holding element, preferably by using an additive manufacturing method, in particular a print-in-place method. By combining different filaments, it is, for example, possible to modify local pressure setting and the characteristics of the model of the at least one tooth and of the holding element may be modelled differently, to achieve a particularly haptic result.

Preferably, the holding element, the at least one artificial tooth, the at least one tooth root and/or the connecting strand comprises a synthetic polymer, in particular polylactic acid (PLA), polyethylene terephthalate (PET), glycol-modified PET (PETG), acrylonitrile butadiene styrene (ABS), TPE (thermoplastic elastomer), PMMA (polymethyl methacrylate), PVA (polyvinyl alcohol), polycarbonate (PC), high-impact polystyrene (HIPS), acrylic styrene acrylonitrile (ASA), low-weight PLA (LW PLA), and/or low-weight TPU (LW TPU). The most important materials in the field of additive manufacturing are thermoplastics, such as PLA, PET and ABS. They allow a particularly sustainable and cost-effective production of the three-dimensional model. PLA has proven to be particularly advantageous for printing bony and/or tooth-like aspects. The advantages of PLA include high strength, high transparency, thermoplasticity and good processing properties. PLA is also biodegradable. In general, PLA is harder and more brittle than ABS due to a higher modulus of elasticity, combined with a higher surface hardness. ABS is softer, easier to form plastically and easier to rework.

At around 160 to 190° C., the melting temperatures for PLA filaments are below the melting temperatures of ABS at around 210 to 240° C. In general, the processing temperature of filaments should be higher than their melting temperature. For example, nozzle temperatures of 180 to 210° C. are suitable for PLA, while nozzle temperatures of 210 to 250° C. are required for ABS. The exact temperatures depend on the filament used and the printer nozzle. A heating bed is not absolutely necessary for additive manufacturing with PLA, but is usually an essential component for ABS.

PETG is a robust, odorless and easy-to-print filament for 3D printing, which is characterized by its particularly high transparency and low viscosity.

Preferably, for example, different degrees of hardness, modulus of elasticity and/or fracture toughness of the at least one holding element, the at least one artificial tooth, the at least one artificial tooth root and/or the connecting strands can be achieved. The holding element, which preferably simulates a jawbone, can have a comparatively high degree of hardness, for example. PLA, for example, is used to produce bony aspects, in particular the holding element and/or the at least one artificial tooth. The at least one artificial tooth, in particular the tooth crown, the tooth neck and/or the at least one tooth root, can also have different degrees of hardness, moduli of elasticity and/or fracture toughness. For example, the crown of the artificial tooth has a higher degree of hardness than the at least one tooth root. The connecting strands can also have the same and/or different degrees of hardness, modulus of elasticity and/or fracture toughness.

According to a further advantageous embodiment of the model according to the invention the model comprises a gingival mask, wherein the gingival mask covers the holding element at least partly. The gingival mask preferably comprises silicone, in particular silicone rubber, for the simulation of soft tissue and serves to realistically simulate the gums. For this purpose, the gingival mask can be colored to match the natural gums. The gingival mask is used in particular for learning and practicing a surgical incision, flap formation and/or suturing techniques, whereby the gingival mask is preferably fiber-reinforced in order to achieve physiologically exact properties. Preferably, the gingival mask is attached to the holding element with an adhesive.

Particularly preferably, the model comprises a textile fabric, in particular a gauze comprising cotton fibers, wherein the textile fabric is at least partially embedded in the gingival mask. The textile fabric may preferably be a gauze, in particular gauze. Gauze is a soft, very loosely woven fabric. Gauze is a light, wide-meshed fabric made of cotton. The textile fabric is preferably embedded in the gingival mask, creating a delicate bond that improves the properties of the gingival mask, in particular achieving a physiologically accurate imitation of the gums. The textile fabric can be used in particular to simulate periosteum, tough fibrous tissue that adheres to bone. Embedding the textile fabric in the gingival mask thus enables realistic surgical soft tissue management. For example, the textile fabric prevents any stretching when the gingival mask is first lifted. The gingival mask can only be stretched once the fabric fibers have been severed.

The model may also include additional layers including artificial connective tissue, muscles and/or glands to further replicate the characteristics of the human mouth. In particular, the holding element and/or the at least one artificial tooth may comprise different materials in order to realistically simulate properties of natural layers and components of the human jaw, for example.

In addition, the model can preferably also be used to model surrounding anatomical shapes and structures. For example, at least one maxillary sinus can be modeled. However, pathological conditions such as a cyst can also be modeled and corresponding interventions such as root tip resections, cystectomies and/or cystostomies can be practiced.

According to a further advantageous embodiment of the model the model comprises an artificial nerve system with at least one artificial nerve, wherein the artificial nerve at least partly extends through the holding element. As already mentioned, the holding element simulates an artificial jawbone, for example. With the three-dimensional model comprising an artificial nerve system with at least one artificial nerve, interventions can therefore be simulated particularly realistically. The position and course of the at least one artificial nerve preferably correspond to those of real nerves, for example in the human upper and/or lower jaw.

Preferably, the artificial nerve system is adapted to detect and/or to differentiate the injection of a fluid and/or damage to the artificial nerve. The fluid may be a local anesthetic, for example. Local anesthetics are drugs that reversibly and locally reduce the excitability of sensitive nerve fibers and thus induce local anesthesia. Damage to the artificial nerve can be caused by a scalpel, a needle or a drill, for example. In particular, the artificial nerve system is adapted to detect potential and/or actual damage to the artificial nerve and/or to differentiate between potential and/or actual damage to the artificial nerve, for example by puncturing the artificial nerve with a needle or by injuring the artificial nerve with a scalpel or a drill. It is also preferable to differentiate between the injection of a fluid, potential damage and/or actual damage to the nerve The artificial nerve system is particularly suitable for detecting the injection of fluids, for example local anesthetics, as well as for determining a potentially or actually damaging contact, for example with a scalpel, a needle or a drill. Preferably, the model enables the influences on the artificial nerve to be weighted and/or differentiated. In particular, the model can be used to differentiate between potentially damaging traumas of varying severity, e.g. a cut with a scalpel. Preferably, the model can also be used to determine whether a fluid has been injected in the vicinity of the artificial nerve, e.g. a correctly applied local anesthetic. For this purpose, the model preferably comprises an electronic component.

For example, the artificial nerve system can use different sensors or technologies to detect the injection of a fluid on the one hand and damage to the artificial nerve on the other hand.

The artificial nerve system preferably comprises at least one capacitive sensor. A capacitive sensor is a sensor that works on the basis of the change in the electrical capacitance of an individual capacitor or a capacitor system. For example, the capacitive sensor measures the capacitance of the model as an overall system. The capacitive sensor can be physically modeled as a capacitor with a dielectric between two plates, in particular, the capacitive sensor functions according to the principle of an ideal plate capacitor. One plate is the capacitive sensor itself. The capacitive sensor is, for example, a wire, preferably a coated wire, particularly preferably a wire coated with varnish. An insulating layer, such as a plastic coating, is also conceivable. The capacitive sensor is preferably located at a simulated nerve position.

The other plate is the area surrounding the capacitive sensor, which couples the sensor, especially weakly, to earth. An electric field is created between the two plates. In this case, the dielectric is basically everything that surrounds the wire. All changes (in the dielectric properties) in this environment change the capacitance of the sensor and thus generate a different sensor value.

For example, the capacitive sensor can be used to detect and/or differentiate between the injection of a fluid and/or damage to the artificial nerve. For example, the capacitance of the sensor changes when fluids come into contact with it. In particular, it is conceivable that both the injection of a fluid and damage to the artificial nerve can be detected and/or differentiated with just one capacitive sensor.

In particular, the capacitive sensor can be used to detect potential and/or actual damage to the artificial nerve. At the same time or with the help of a separate component, for example a wire, an injection of a fluid, for example a local anesthetic, can be detected. The injection of a fluid can be determined, for example, by detecting a short circuit between two wires. The nerve positions can be suitable for simulating anesthesia techniques, for example.

Preferably, it is possible to use the capacitive sensor to detect and/or differentiate damage to the artificial nerve and/or the injection of a fluid. For example, the injection of a fluid in the vicinity of the simulated nerve, which is designed as a capacitive sensor, in particular as a wire, preferably a coated wire, causes a comparatively small change in capacitance. Damage to the capacitive sensor, in particular the wire and/or the coating of the wire, on the other hand, results in a comparatively strong change in the dielectric and thus a strong change in the capacitance, for example.

In particular, the sensitivity of the capacitive sensor can be adjusted. For example, when using a low sensitivity, only strong changes are detected. It is conceivable that merely blunt contact with the artificial nerve is not detected and/or differentiated from actual damage to the artificial nerve. A sharp, cutting contact with the artificial nerve, e.g. by a scalpel, on the other hand, is detected and/or signaled, for example by means of an indicator.

It is conceivable to specify at least one limit value that allows conclusions to be drawn about a successful or unsuccessful action performed on the model, in particular a successful or unsuccessful intervention. For example, if a limit value is exceeded or not reached, damage to the nerve and/or a correctly or incorrectly injected fluid can be assumed. The relevant limit values can depend, for example, on the length of the capacitive sensor, in particular the wire, the materials used and/or the environment of the model. Other factors are also conceivable.

In particular, it is possible to use a rough limit value in combination with a smoothing filter, preferably over some of the last measurements, e.g. the average of the last five measurements at 50 measurements per second. This limit-based approach is particularly suitable due to a relatively strong measurable signal.

The capacitive sensor can be used to detect, for example, the speed and/or the course of a change in capacitance. A signal detected by the capacitive sensor can, for example, be evaluated in comparison to a specific value, such as an average value of the last measurements or a value obtained using another filter (such as a smoothing filter). In particular, proportional and/or differential processing of the signal from the capacitive sensor can be useful. For example, the artificial nerve system can comprise a differential and/or proportional sensor. In this way, not only the absolute value, but also the rate of change of the capacitance can be measured.

Further improvements are possible, e.g. by calibrating the artificial nerve as soon as all preparations prior to the simulation have been completed. In particular, it is conceivable to calibrate the artificial nerve system, especially the capacitive sensor, to a basic value, preferably at a suitable time, such as before the start of an exercise.

The use of a capacitive sensor, in particular a coated wire, as an artificial nerve preferably allows a simple and inexpensive replacement of a damaged artificial nerve, e.g. after it has been severed. Accordingly, the model can be reused.

The artificial nerve system preferably comprises at least one indicator that is functionally coupled to the artificial nerve to indicate the injection of a fluid and/or damage to the artificial nerve. An indicator can advantageously provide the user of the three-dimensional model with feedback on its use, in particular on the success and/or failure of an intervention.

The at least one indicator may, for example, be an acoustic indicator, such as a loudspeaker, and/or a visual indicator, such as a light-emitting element or a display device such as a display. The indicator can therefore provide the user with an acoustic and/or visual signal, for example, which allows conclusions to be drawn about the quality of the intervention. The three-dimensional model preferably provides the user with feedback on its use, for example on the performance of a specific dental or oral surgery procedure. The at least one indicator may preferably be suitable for indicating a condition of the at least one artificial nerve.

For example, the model is suitable for communicating with at least one communication device. The communication device is preferably a device different from the model. For example, the communication device is a terminal device, preferably a mobile terminal device such as a portable computer, e.g. a laptop computer, a tablet computer, a wearable, a personal digital assistant or a smartphone. Communication can take place in particular via a wired or preferably wireless connection by means of a communication system. Examples of a communication system are a local area network (LAN), a wide area network (WAN), a wireless network (WLAN), a wired network, a mobile network, a telephone network, a satellite network and/or the Internet.

Preferably, the communication device communicates with the model via (at least) one local wireless network (e.g. according to the IEEE 802.11 standard, the Bluetooth standard (e.g. version 1, 2, 3, 4 (in particular Bluetooth LE) and/or a future standard), a mobile radio standard (such as the 2G, 3G, 4G and/or 5G standard) and/or the NFC standard).

In particular, the communication device can communicate with the model and/or with a data processing system. Communication can take place both directly and indirectly (via other devices). The data processing system can, for example, be a mobile or stationary data processing system. For example, the data processing system is a server. Preferably, the communication device communicates with the data processing system at least partially via a wireless network, a mobile network, a telephone network, a satellite network and/or the Internet.

Preferably, the three-dimensional model is capable of communicating with a communication device to transmit information about the state of the model, in particular the artificial nerve. Thus, it is preferably possible for the communication device, in particular a mobile terminal device, in particular by means of an application set up on it, to act as an indicator which is functionally coupled to the model, preferably the artificial nerve system, in order to indicate the injection of a fluid and/or damage to the nerve. For example, a perceptible signal can be emitted via the communication device when the at least one artificial nerve has been damaged and/or a fluid has been detected in the immediate vicinity of the artificial nerve.

The three-dimensional model preferably comprises a central control unit and/or is designed to be connected to such a unit. In particular, the control unit makes it possible to bundle the information output by one or more models. The control unit could also include a display, for example a display, to show the information received. This configuration would be conceivable, for example, for test scenarios in which a large number of models transmit their current status, for example via WLAN or Bluetooth, to a data processing system, such as a server, and/or to a communication device. The inspectors can, for example, monitor the status of the model or models on one or more communication devices, in particular end devices, e.g. by means of a website provided by the data processing system, in particular the server.

According to a second aspect of the present invention, the above problem is solved by a method for producing a three-dimensional model for simulating medical, in particular dental, treatments, in particular a model according to the invention, comprising at least one holding element for receiving artificial teeth, at least one artificial tooth, wherein the artificial tooth comprises at least one artificial tooth root, wherein the artificial tooth root is at least partially received in a recess of the holding element, characterized in that the method comprises a simultaneous manufacturing of the at least one holding element and the at least one artificial tooth by means of an additive manufacturing method, in particular a print-in-place method, wherein a plurality of connecting strands are formed between the holding element and the artificial tooth, in particular the artificial tooth root.

Simultaneous manufacturing of the at least one holding element and the at least one artificial tooth means, in particular, one-piece manufacturing in one manufacturing step. For this purpose, for example, at least one connecting strand, in particular a plurality of connecting strands, is formed between the holding element and the tooth, in particular the at least one artificial tooth root. In particular, the connecting strands end both at the artificial tooth, in particular the artificial tooth root, and at the holding element. In this way, the artificial tooth, in particular the artificial tooth root, is connected to the holding element by the connecting strands, in particular anchored in the holding element. Preferably, the at least one holding element, the at least one artificial tooth, in particular the at least one artificial tooth root, and the plurality of connecting strands are manufactured in one piece in a single manufacturing step.

One of the established additive manufacturing methods, such as 3D printing, is fused layering, in which a workpiece is built up layer by layer from a meltable plastic or molten metal. The three-dimensional model can be produced using fused layer modeling (FLM), fused filament fabrication (FFF) or fused deposition modeling (FDM), for example. For example, 3D printing can be used to convert individual virtual 3D models from a computer-aided design (CAD) into realistic, haptic models.

Compared to casting, especially injection molding, additive methods such as melt layering have the advantage that the time-consuming production of molds and mold changes are no longer necessary. Compared to all material-removing method such as cutting, turning and drilling, additive methods have the advantage of eliminating the additional processing step after the master mold. Complex geometries in particular can be produced using 3D printing.

Using a print-in-place method, the at least one holding element and the at least one tooth can be produced simultaneously, preferably in a single manufacturing step, whereby the same and/or different materials can be used for the components. For example, the at least one artificial tooth can be printed with a different filament than the at least one holding element. By combining different filaments and modifying local print settings, the properties of the components can be modeled differently in order to achieve a particularly advantageous haptic experience. In this way, realistic and in particular individual demonstration and simulation models can be produced.

It has been shown that the simultaneous manufacturing of the at least one holding element and the at least one artificial tooth by means of an additive manufacturing method, in particular a print-in-place method, whereby a large number of connecting strands are formed between the holding element and the artificial tooth, in particular the artificial tooth root, advantageously enables a particularly cost-effective, sustainable and realistic production of a three-dimensional model. It is preferably possible to reuse more than 50%, preferably more than 80%, particularly preferably more than 90% of the materials used to produce the model. In particular, the method comprises simultaneous manufacturing of the at least one holding element, the at least one artificial tooth and at least one connecting strand, preferably the plurality of connecting strands.

Due to the plurality of connecting strands between the at least one holding element and the at least one artificial tooth, in particular the at least one artificial tooth root, the artificial tooth can be fixed in a natural way, in particular semi-elastically, in the recess of the holding element. In particular, the connecting strands can be made semi-elastic. In this way, a substantially stable connection between the holding element and the at least one artificial tooth can be ensured, while the connecting strands are nevertheless at least partially movable and do not break even when subjected to low forces. The connection between the artificial tooth, in particular the at least one artificial tooth root, and the holding element can in particular be simultaneously stable and resilient. It has been shown that the model according to the invention in this way allows a particularly realistic, physiologically accurate simulation of both routine and complex medical interventions, in particular dental treatments.

The elasticity of the connecting strands is influenced, for example, by their diameter and/or the material used. It is also conceivable that a different elasticity and/or a differently firm hold of the at least one artificial tooth in the holding element can be achieved with a different length of the connecting strands.

The model according to the invention preferably offers trainee and qualified dentists and surgeons the possibility of training various surgical procedures with a single model and with particularly realistic experience, wherein the model is preferably substantially imitated in shape and material of a natural upper and/or lower jaw, in particular a patient case.

According to a first advantageous embodiment of the method according to the invention, the method further comprises an at least partial application of a gingival mask to the holding element. The gingival mask is preferably applied after the at least one holding element, the at least one artificial tooth and the connecting strands have been printed, preferably in one process step by means of a print-in-place method. For example, silicone is injected or poured into the recess of a matrix and then pressed against the printed model. It is also conceivable to pour silicone over the other components. The gingival mask can be applied to the at least one holding element using an adhesive, for example.

Preferably, the method further comprises applying a textile fabric, in particular a gauze made of cotton fibers, to the holding element, wherein the textile fabric is at least partially embedded in the gingival mask. The textile fabric is preferably applied to the at least one holding element after the simultaneous production of the at least one holding element and the at least one artificial tooth and optionally the connecting strands, preferably by means of a print-in-place method, and before the gingival mask is applied. In this way, the textile fabric is advantageously embedded in the gingival mask. Preferably, the textile fabric can be glued to the holding element, for example, and then poured over with silicone or pressed into a mold with silicone.

According to a further advantageous embodiment of the method according to the invention, the method further comprises integrating an artificial nerve system comprising at least one artificial nerve into the model, wherein the artificial nerve is at least partially guided through the holding element.

For example, a capacitive sensor for simulating an artificial nerve can be integrated into the holding element. The position and course of the artificial nerve preferably correspond to real nerves in the upper or lower jaw. The artificial nerve system is particularly preferably adapted to detect and/or differentiate the injection of a fluid and/or damage to the artificial nerve. In this way, interventions on the model can be imitated even more precisely.

According to a third aspect of the present invention, the problem shown above is solved by a three-dimensional model for simulating medical, in particular dental, treatments, comprising at least one holding element, in particular for holding artificial teeth, an artificial nerve system comprising at least one artificial nerve, wherein the artificial nerve extends at least partially through the holding element, characterized in that the artificial nerve system is adapted to detect and/or differentiate the injection of a fluid and/or damage to the artificial nerve.

The position and course of the at least one artificial nerve preferably correspond to those of real nerves, for example in the human upper and/or lower jaw or in human limbs, for example in a human arm. Particularly in the area of the lower jaw, the risk to large nerves with areas of autonomy represents an enormous difficulty for surgeons or dentists. The artificial nerve system of the three-dimensional model can be used to imitate the inferior alveolar nerve, in particular the mental nerve, in the lower jawbone and/or the lingual nerve.

It is conceivable, for example, that the three-dimensional model is a model of a human or animal upper and/or lower jaw. The model can, for example, comprise a gingival mask, in particular a fiber-reinforced gingival mask, which at least partially covers the holding element and thus simulates gums in a realistic manner.

In addition, the model can be used to demonstrate and/or simulate local anesthesia and/or nerve surgery in other anatomical regions. For example, the model is used to demonstrate and/or simulate axillary plexus anesthesia. In this case, the holding element can be an artificial human arm, for example. Axillary plexus anesthesia is a regional anesthesia procedure that enables surgical interventions on the arm. The nerves of the brachial plexus, in particular the median nerve, ulnar nerve, radial nerve and/or musculocutaneous nerve, are reversibly blocked by injecting local anesthetics in the area of the armpit.

The artificial nerve system is particularly suitable for detecting the injection of fluids, for example local anesthetics, as well as for determining a potentially damaging and/or actual damaging contact, for example with a scalpel or a drill. Preferably, the model enables the influences on the artificial nerve to be weighted and/or differentiated. In particular, the model can be used to differentiate between potentially damaging traumas of varying severity. For example, it is possible to evaluate the contact strength. For example, only minor contact can be distinguished from a cut with a scalpel. Preferably, the model can also be used to determine whether a fluid has been injected near the artificial nerve, e.g. a correctly applied local anesthetic. For this purpose, the model preferably comprises an electronic component.

According to a first advantageous embodiment of the model according to the invention, the artificial nerve system comprises a capacitive sensor. In particular, the capacitive sensor can be used to detect damage to the artificial nerve and/or the injection of a fluid. For this purpose, the capacitive sensor preferably assumes the position of a imitated real nerve. The use of a capacitive sensor as an artificial nerve allows a particularly simple and inexpensive replacement of a damaged artificial nerve, e.g. after it has been severed. Accordingly, the model can also be reused after an intervention.

If, for example, the at least one artificial nerve was injured during the removal of a tooth, the artificial nerve can be replaced and the further interventions, in particular extractions, can be carried out, whereby the artificial nerve could detect renewed damage. In particular, if several interventions are to be performed on one model, e.g. the removal of several teeth on one side in the lower jaw is to be simulated, the same model can be used for all successive interventions.

Preferably, the capacitive sensor comprises a coated wire, in particular a wire coated with varnish. Alternatively or additionally, a capacitive sensor comprising a wire coated with plastic is conceivable. These are particularly cost-effective components that are suitable for realistically realizing the three-dimensional model.

According to a further advantageous embodiment of the model according to the invention, the nerve system comprises at least one indicator which is functionally coupled to the artificial nerve in order to indicate the injection of a fluid and/or damage to the nerve. In particular, an indicator provides the user of the model with feedback on its use, for example on a successful or unsuccessful intervention.

Preferably, the indicator comprises a visual and/or an acoustic indicator. The at least one indicator may, for example, be an acoustic indicator such as a loudspeaker or a visual indicator such as a light-emitting element. An acoustic and/or visual signal can thus, for example, allow conclusions to be drawn about the quality, in particular the success and/or failure, of the intervention.

It is also conceivable for the model to communicate with a communication device, for example via Bluetooth and/or WLAN. Preferably, the three-dimensional model is suitable for communicating with a communication device in order to transmit information about the state of the model, in particular the artificial nerve. For example, it is possible that the artificial nerve model, in particular the artificial nerve, is connected to a data processing unit, which in turn is connected to a communication device, for example a mobile terminal. Thus, it is preferably possible for the mobile terminal device, in particular an application set up on it, to act as an indicator that is functionally coupled to the artificial nerve in order to indicate the injection of a fluid and/or damage to the nerve. For example, a perceptible signal can be emitted via the mobile terminal device if the at least one artificial nerve has been damaged and/or a fluid has been detected in the immediate vicinity of the artificial nerve.

The artificial nerve system can also include other electronic components such as microcontrollers and passive components such as light-emitting elements and/or resistors. The capacitance of the capacitive sensor used as an artificial nerve changes, for example, when fluids come into contact with the sensor. This can be detected and processed by a microcontroller, for example, in order to trigger a digital signal that can then be used for feedback.

The aspects described herein should also be understood to be disclosed in combination with each other. Likewise, the advantageous embodiments of the various aspects described herein should also be understood to be disclosed in combination with the other aspects. For example, in particular, the embodiments relating to the artificial nerve system of the three-dimensional model of the first aspect also apply to the three-dimensional model of the third aspect.

There are a large number of possibilities for designing the models according to the invention and the method according to the invention. Reference is made on the one hand to the claims following claims 1, 12 and 16 and to the description of embodiments in conjunction with the drawing.

The drawing shows in

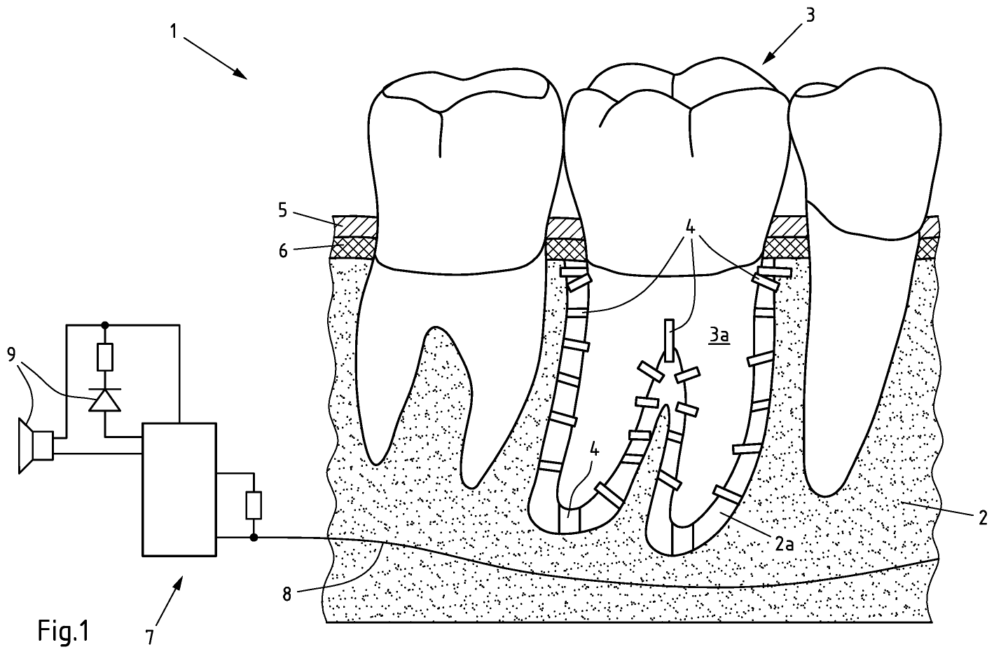

FIG. 1 in a schematic view a cross section of an example embodiment of the three-dimensional model according to the first aspect of the invention, and in

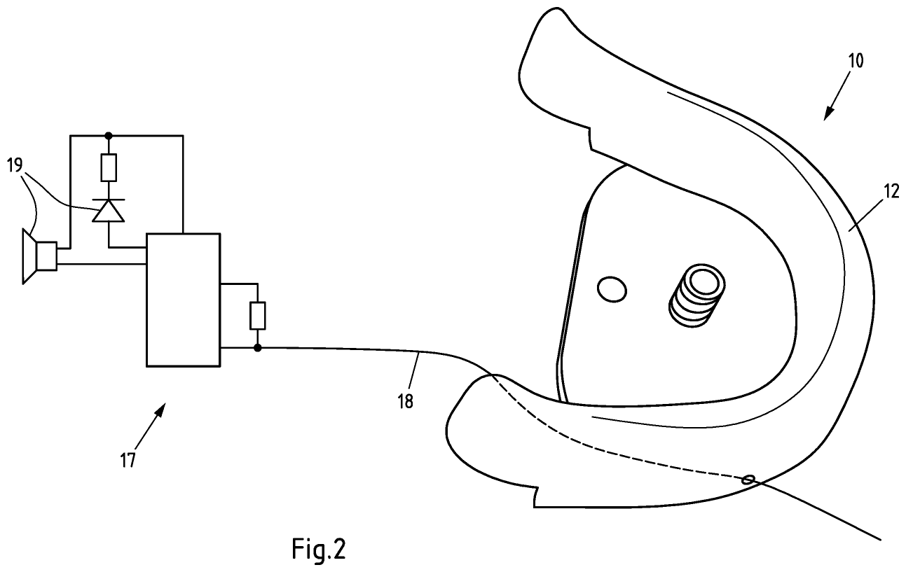

FIG. 2 in a schematic view a top-view of an example embodiment of the three-dimensional model according to the third aspect of the invention.

FIG. 1 shows a three-dimensional model 1 for simulating medical, in particular dental, treatments. The model 1 comprises at least one holding element 2 for receiving artificial teeth and at least one artificial tooth 3, wherein the artificial tooth 3 comprises at least one artificial tooth root 3a, wherein the artificial tooth root 3a is at least partially received in a recess 2a of the holding element 2. The holding element 2 is, for example, an artificial jawbone which is imitated from a human lower jawbone. The holding element 2 is particularly suitable for insertion into common phantoms. The artificial tooth 3 comprises three artificial tooth roots 3a, which are accommodated in a recess 2a of the holding element 2. The recess 2a of the holding element 2 preferably forms an image of the artificial tooth roots 3a. For this purpose, the recess 2a has, for example, inclined, upwardly diverging side flanks. To match this, the artificial tooth roots 3a are conical in shape.

There is a gap between the holding element 2 and the artificial tooth roots 3a. For example, the gap has a width of 0.1 to 0.9 mm, preferably 0.1 to 0.5 mm, particularly preferably 0.1 to 0.3 mm.

A plurality of connecting strands 4 is formed between the holding element 2 and the artificial tooth 3, in particular the artificial tooth root 3a. The holding element 2, the artificial tooth 3, in particular the artificial tooth roots 3a, and the connecting strands 4 are formed in one piece, with the connecting strands 4 each ending both at an artificial tooth root 3a and at the holding element 2. The connecting strands 4 are formed substantially over the entire root surface of the artificial tooth roots 3a and extend in the direction of the holding element 2. In particular, the connecting strands 4 connect the at least one artificial tooth 3, in particular the at least one artificial tooth root 3a, to the holding element 2 in a direct and therefore shortest way. In particular, at least one connecting strand 4 has an angle of 45 to 135 degrees, preferably substantially 90 degrees to the tooth or root surface.

By connecting the at least one artificial tooth 3 to the holding element 2 via the large number of connecting strands 4, the model 1 can be used to simulate a physiologically exact tooth removal, for example. Model 1 is particularly suitable for simulating realistic extractions and osteotomies, root tip resections and plastic wound closures. Model 1 preferably allows complication management, e.g. in the case of root fractures, flexible case design, e.g. ankylosed and impacted teeth, and in particular the most accurate patient case simulation possible. Preferably, different degrees of difficulty of simulated interventions can be represented with the model 1. In addition, the model 1 can preferably be used for a variety of practice and/or demonstration scenarios. For example, the extraction of a first artificial tooth 3, which is designed e.g. as an imitated canine, and a second artificial tooth 3, which is designed e.g. as an imitated molar, can be performed on the same model 1.

At least one connecting strand 4, in particular a majority of the connecting strands 4, is formed laterally of the tooth root 3a of the artificial tooth 3. In addition, a connecting strand 4 is formed at each root tip of the artificial tooth roots 3a. In some cases, connecting strands 4 are also formed in the area of the tooth neck, the transition between the tooth crown and the tooth roots 3a. The connecting strands 4, which are formed at the root tip, have a round cross-section, while the connecting strands 4 lateral to the artificial tooth 3, in particular the artificial tooth roots 3a, have an angular, in particular rectangular cross-section.

The diameter of the connecting strands 4 formed laterally of the artificial tooth 3, in particular of the artificial tooth roots 3a, is smaller than the diameter of the connecting strands 4 formed at the root tips.

The holding element 2, the at least one artificial tooth 3 and/or at least one connecting strand 4 are at least partly formed from different materials and/or the same material. The components, for example, comprise a synthetic polymer, in particular polylactic acid (PLA), polyethylene terephthalate (PET), glycol-modified PET (PETG), acrylonitrile butadiene styrene (ABS), TPE (thermoplastic elastomer), PMMA (polymethyl methacrylate), PVA (polyvinyl alcohol), polycarbonate (PC), high-impact polystyrene (HIPS), acrylic styrene acrylonitrile (ASA), low-weight PLA (LW PLA), and/or low-weight TPU (LW TPU). Preferably, for example, different degrees of hardness, modulus of elasticity and/or fracture toughness of the at least one holding element 2, the at least one artificial tooth 3, the at least one artificial tooth root 3a and/or the connecting strands 4 can be achieved.

In addition, the model 1 comprises an artificial nerve system 7 with at least one artificial nerve 8, whereby the artificial nerve 8 extends at least partially through the holding element 2. Nerve cords usually run in both the upper and lower jaw, which must be taken into account during surgical and dental interventions. The three-dimensional model 1 can be used, for example, to imitate the inferior alveolar nerve, in particular the mental nerve, in the lower jawbone and/or the lingual nerve.

The artificial nerve system 7 is adapted in particular to detect and/or differentiate the injection of a fluid and/or damage to the artificial nerve 8. For this purpose, the nerve system 7 has a capacitive sensor as artificial nerve 8. The capacitive sensor is, for example, a coated wire, which is in particular coated with varnish. An insulating layer, such as a plastic coating, is also conceivable.

Furthermore, the artificial nerve system 7 of the model 1 comprises at least one indicator 9 which is functionally coupled to the artificial nerve 8 in order to indicate the injection of a fluid and/or damage to the artificial nerve 8.

The model 1 preferably comprises a gingival mask 5, wherein the gingival mask 5 at least partially covers the holding element 2. Particularly preferably, the model I also comprises a textile fabric 6, in particular a gauze comprising cotton fibers. In particular, the textile fabric 6 is at least partially embedded in the gingival mask 5.

A method for producing a three-dimensional model 1 for simulating medical, in particular dental, treatments comprises the simultaneous manufacturing of at least one holding element 2 for holding artificial teeth and at least one artificial tooth 3 by means of an additive manufacturing method, in particular a print-in-place method. The artificial tooth 3 comprises at least one artificial tooth root 3a, which is at least partially accommodated in a recess 2a of the holding element 2. A plurality of connecting strands 4 are formed between the holding element 2 and the artificial tooth 3, in particular the artificial tooth root 3a.

One of the established additive manufacturing methods is fused layering, in which a workpiece is built up layer by layer from a meltable plastic or molten metal. In the melt layering method, a grid of dots is first applied to a surface. The dots are created by liquefying a wire-shaped plastic, metal and/or wax material by heating, applying it by extrusion using a nozzle and then hardening it by cooling it at the desired position in a grid on the working plane. Model 1 is constructed by repeatedly traversing a working plane line by line and then moving the working plane upwards in stacks so that model 1 is created layer by layer. Protruding parts can be created with added support structures, for example.

The print-in-place method, which is carried out for example with a filament deposition 3D printer, for example with an Ultimaker S5, makes it possible to print the at least one artificial tooth 3 and the at least one holding element 2 simultaneously, preferably in one process step, whereby the artificial tooth 3 is printed for example with a different filament than the holding element 2.

By combining different filaments and modifying local print settings, the properties of the tooth 3 and the holding element 2 can be modeled differently in order to achieve a particularly good haptic model 1. The filament for both the holding element 2 and the at least one tooth 3 is preferably a thermoplastic material, for example ABS or PLA, which is used in wire form on rolls in the print-in-place method. The diameter of the connecting strands 4 is in particular adapted to the 3D printer used so that the connecting strands 4 can be printed with a single thickness of filament, so that individual strands connect the holding element 2 and the artificial tooth 3 to each other, creating a semi-elastic connection between the holding element 2 and the artificial tooth 3.

The method preferably further comprises integrating an artificial nerve system 7 comprising at least one artificial nerve 8 into the model 1, wherein the artificial nerve 8 is guided at least partially through the holding element 2. The artificial nerve 7 of the model 1 can be designed as a capacitive sensor. For example, the capacitive sensor is a wire coated with varnish. Alternatively, it can also be a wire coated with plastic. The use of a capacitive sensor as an artificial nerve 8 allows the damaged artificial nerve 8 to be replaced easily and cheaply, e.g. after it has been severed. Accordingly, the model 1 is in any case partially reusable.

The artificial nerve system 7 is adapted to detect and/or differentiate the injection of a fluid and/or damage to the artificial nerve 8. The artificial nerve system 7 thus enables particularly realistic simulations of surgical and dental interventions.

Furthermore, the artificial nerve system 7 comprises an indicator 9 that is functionally coupled to the artificial nerve 8 to indicate the injection of a fluid and/or damage to the artificial nerve 8. The user can thus receive feedback during a simulated procedure if the artificial nerve 8 has been damaged or if a fluid has been applied correctly or incorrectly. It is conceivable that the indicator 9 can reproduce graded signals, for example depending on the contact strength and/or the degree of damage to the nerve 8.

The method preferably further comprises an at least partial application of a gingival mask 5 to the holding element 2. The three-dimensional model 1 comprises—in addition to the holding element 2, at least one artificial tooth 3 and a plurality of connecting strands 4—a gingival mask 5, wherein the gingival mask 5 at least partially covers the holding element 2.

The gingival mask 5 is applied after the at least one holding element 2, the at least one artificial tooth 3 and the connecting strands 4 have been printed simultaneously using an additive manufacturing process, in particular a print-in-place process. To produce the gingival mask 5, silicone, for example G1-MASK, Coltene®, Liechtenstein, is preferably injected or cast into the recess of a matrix and pressed against the 3D-printed model 1 comprising at least one holding element 2, at least one artificial tooth 3 and a plurality of connecting strands 4. Alternatively, the printed model 1 can be poured over with silicone.

Before applying the gingival mask 5, a textile fabric 6, in particular a gauze made of cotton fibers, is preferably applied to the holding element 2. For example, an unfolded cotton compress can be used as the textile fabric 6, which is glued to the surface of the holding element 2.

As can be seen in FIG. 1, the model 1 comprises a textile fabric 6, in particular a gauze comprising cotton fibers, which can be at least partially embedded in the gingival mask 5.

This can be done, for example, by pouring silicone over the model 1 with the applied textile fabric 6, preferably the gauze. Alternatively, the model 1 with the applied textile fabric 6 can be inserted into a casting mold. Silicone can then be poured around the model 1 using the casting mold.

This sequence embeds the textile fabric 6, in particular the cotton compress, in the silicone, creating a delicate connection that significantly improves the properties of the three-dimensional model 1. The compress simulates the periosteum, the tough fibrous tissue that adheres to the bone. The compress allows a key concept of surgical soft tissue management to be experienced realistically: When the gingival mask 5, which is reinforced with fibers by the textile fabric 6, for example the cotton compress, is lifted for the first time, the textile fabric 6 prevents any stretching. Only an incision of the textile fabric 6 allows the gingival mask 5 to stretch

The three-dimensional model 10 shown in FIG. 2 for simulating medical, in particular dental, treatments comprises at least one holding element 12, in particular for holding artificial teeth, an artificial nerve system 17 comprising at least one artificial nerve 18, wherein the artificial nerve 18 extends at least partially through the holding element 12. In this case, the holding element 12 is designed as an artificial human lower jaw. The artificial nerve 18 can, for example, imitate the inferior alveolar nerve, the mental nerve and/or the lingual nerve.

Alternatively, the model 10 comprising the artificial nerve system 17 may be used to demonstrate and/or simulate local anesthesia and/or nerve surgery in other anatomical regions. For example, the holding element 12 may be an artificial human arm, in which case the model 10 may be used to demonstrate and/or simulate axillary plexus anesthesia.

The artificial nerve system 17 is adapted to detect and/or differentiate the injection of a fluid and/or damage to the artificial nerve 18. The artificial nerve system 17 is in particular suitable for detecting the injection of fluids, for example local anesthetics, as well as for determining a potentially or actually damaging contact, for example with a scalpel, a needle or a drill. Therefore the artificial nerve system 17 in particular comprises a capacitive sensor. The capacitive sensor preferably comprises a coated wire, in particular a wire coated with varnish. Alternatively, a capacitive sensor comprising a wire coated with plastic is conceivable.

Furthermore, the nerve system 17 comprises at least one indicator 19 which is functionally coupled to the artificial nerve 18 in order to indicate the injection of a fluid and/or damage to the artificial nerve 18. The indicator in particular provides a feedback to the user on the success and/or failure of interventions carried out on the model 10.

For this purpose, the indicator 19 comprises, for example, a visual and/or an acoustic indicator. If, for example, the artificial nerve 18 is damaged during the simulated procedure, a visual signal appears, for example a light-emitting element lights up, and/or an acoustic signal, for example a tone sounds from a loudspeaker. Depending on the contact strength, the intensity of the signal can be graded, for example. Similarly, the indicator 19 can provide feedback on a simulated injection.

The model 10 can also include other electronic components such as active components, for example microcontrollers, in particular an Arduino Nano microcontroller, or passive components such as light-emitting elements or resistors.

For example, the model 10 comprises a microcontroller, which is preferably connected to the artificial nerve 17, preferably comprising a capacitive sensor, in particular a coated wire, via a printed circuit board. This runs at least partially through the holding element 12, which is designed as an artificial lower jaw, for example, and simulates the inferior alveolar nerve, for example.

It is conceivable that the signal is not triggered by a merely blunt touch. However, in the event of sharp, cutting contact with the artificial nerve 17, e.g. with a scalpel, the indicator 19, for example in the form of a blue light-emitting element, is triggered.

The model 1, 10 preferably offers in particular trainee or qualified dentists and surgeons the possibility of training various medical procedures with a single model and with particularly realistic experiences. The model 1, 10 can preferably also be used to model surrounding anatomical shapes and structures. For example, at least one maxillary sinus can be modeled. However, pathological conditions such as a cyst can also be modeled and corresponding interventions such as root tip resections, cystectomies and/or cystostomies can be practiced. In addition to tooth extractions, surgical incisions and/or injections, the model 1, 10 can also be used, for example, to simulate a jaw fracture, sinus floor elevation, implantation, tooth transplantation, mobilization, button bonding, anterior tooth trauma and/or orthognathic surgery

The model 1, 10 can be customized. In particular, the model 1. 10 can be adapted to a real patient case.

1. Three-dimensional model for simulating medical, in particular dental, treatments, comprising:
at least one holding element for receiving artificial teeth,
at least one artificial tooth, wherein the artificial tooth comprises at least one artificial tooth root, wherein the artificial tooth root is at least partly received in a recess of the holding element,
characterized in that
a plurality of connecting strands is formed between the holding element and the artificial tooth, in particular between the artificial tooth root.

2. Model according to claim 1,
characterized in that
the connecting strands are substantially formed to be distributed across the whole root area.

3. Model according to claim 1,
characterized in that
the connecting strands extend in direction of the holding element.

4. Model according to claim 1,
characterized in that
at least one connecting strand is formed laterally of the tooth root of the artificial tooth.

5. Model according to claim 1,
characterized in that
the holding element, the at least one artificial tooth and/or the connecting strand comprises a synthetic polymer, in particular polylactic acid (PLA), polyethylene terephthalate (PET), glycol-modified PET (PETG), acrylonitrile butadiene styrene (ABS), TPE (thermoplastic elastomer), PMMA (polymethyl methacrylate), PVA (polyvinyl alcohol), polycarbonate (PC), high-impact polystyrene (HIPS), acrylonitrile styrene acrylate (ASA), low-weight PLA (LW PLA), and/or low-weight TPU (LW TPU).

6. Model according to claim 1,
characterized in that
the model comprises a gingival mask, wherein the gingival mask at least partly covers the holding element.

7. Model according to claim 6,
characterized in that
the model comprises a textile fabric, in particular a gauze comprising cotton fibers, wherein the textile fabric is embedded at least partly in the gingival mask.

8. Model according to claim 1,
characterized in that
the model comprises an artificial nerve system with at least one artificial nerve, wherein the artificial nerve extends at least partly through the holding element.

9. Model according to claim 8,
characterized in that
the artificial nerve system is adapted to detect and/or to differentiate the injection of a fluid and/or damage to the artificial nerve.

10. Model according to claim 8,
characterized in that
the artificial nerve system comprises at least one capacitive sensor.

11. Model according to claim 9,
characterized in that
the artificial nerve system comprises at least one indicator that is functionally coupled to the artificial nerve to indicate the injection of a fluid and/or damage to the artificial nerve.

12. Method for producing a three-dimensional model for simulating medical, in particular dental, treatments, in particular according to one of the previous claims, comprising:
at least one holding element for receiving artificial teeth,
at least one artificial tooth, wherein the artificial tooth comprises at least one artificial tooth root, wherein the artificial tooth root is received at least partly in a recess of the holding element,
characterized in that
the method comprises:
simultaneous manufacturing of the at least one holding element and of the at least one artificial tooth by means of an additive manufacturing method, in particular a print-in-place method, wherein a plurality of connecting strands are formed between the holding element and the artificial tooth, in particular the artificial tooth root.

13. Method according to claim 12,
characterized in that
the method further comprises:
at least partly applying a gingival mask to the holding element.

14. Method according to claim 13,
characterized in that
the method further comprises:
applying a textile fabric, in particular a gauze made of cotton fibers, to the holding element, wherein the textile fabric is at least partly embedded in the gingival mask.

15. Method according to claim 12,
characterized in that
the method further comprises:
integrating an artificial nerve system comprising at least one artificial nerve into the model, wherein the artificial nerve is at least partly guided through the holding element.

16. Three-dimensional model for simulating medical, in particular dental, treatments, comprising:
at least one holding element-, in particular for receiving artificial teeth,
an artificial nerve system comprising at least one artificial nerve, wherein the artificial nerve extends at least partly through the holding element-,
characterized in that
the artificial nerve system is adapted to detect and/or to differentiate the injection of a fluid and/or damage of the artificial nerve.

17. Model according to claim 16,
characterized in that
the artificial nerve system comprises a capacitive sensor.

18. Model according to claim 17,
characterized in that
the capacitive sensor comprises a coated wire, in particular a wire coated with varnish.

19. Model according to claim 16,
characterized in that
the nerve system comprises at least one indicator that is functionally coupled to the artificial nerve to indicate the injection of a fluid and/or damage of the artificial nerve.

20. Model according to claim 19,
characterized in that
the indicator comprises a visual and/or an acoustic indicator.
